(19) United States
(12) Patent Application Publication
(10) Pub. No.: US 2009/0035409 A1
(43) Pub. Date: Feb. 5, 2009

(54) Automatic Block Making Machine

(75) Inventor: Quintin Booysen, Germiston (ZA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hydraform Developments (Proprietary) Limited, Libradene (ZA)

(21) Appl. No.: 12/280,160

(22) PCT Filed: Feb. 15, 2007
(86) PCT No.: PCT/IB2007/000349

§ 371 Date: Aug. 20, 2008

(30) Foreign Application Priority Data
Feb. 22, 2006 (ZA) 2006/01556

(51) Int. Cl. B28B 3/02

(52) U.S. Cl. 425/149

(57) ABSTRACT

The invention provides block forming apparatus with a compression chamber having upper and lower opposed ends, and defining a common inlet and outlet at the upper end of the compression chamber, via which the compression chamber can be charged with block forming material, and via which a formed block can be ejected from the compression chamber. The compression chamber is mounted pivotably on a frame so that it can be pivoted sequentially through different positions. A lower ram is movable between an extended position, to compress the block forming material from the bottom, and a retracted position. An upper ram is movable between a retracted position clear of the common inlet and outlet, and a closed position. A set of actuators move the compression chamber between a first, loading position, a second, compacting position and a third, ejection position.

### BACKGROUND OF THE INVENTION

This invention relates to an automated apparatus for forming blocks such as building blocks.

A number of block making machines exist, ranging from simple hand-operated machines to more complex hydraulically operated machines. However, even the more sophisticated machines can be quite labour intensive to operate.

It is an object of the invention to provide block making apparatus that offers a degree of automation and is relatively non-labour intensive to operate.

### SUMMARY OF THE INVENTION

According to the invention there is provided block forming apparatus comprising:
a compression chamber having upper and lower opposed ends;
a common inlet and outlet at the upper end of the compression chamber, via which the compression chamber can be charged with block forming material, and via which a formed block can be ejected from the compression chamber;
a frame arranged to support the compression chamber;
a lower ram movable between an extended position in which it extends into the compression chamber towards the upper end thereof, to compress the block forming material from the bottom, and a retracted position towards the lower end thereof; and
an upper ram movable between a retracted position, and a closed position in which it extends into the compression chamber to compress the block forming material from the top,
   wherein the compression chamber is movable on the frame between a first, loading position in which the compression chamber can be charged with block forming material via the common inlet and outlet; a second, compacting position in which the upper and lower rams can extend into the compression chamber; and a third, ejection position in which the lower ram can eject the formed block via the common inlet and outlet.

The upper and lower rams are preferably controlled by respective hydraulic actuators arranged to exert substantially equal forces on the rams, so that block forming material in the compression chamber is subjected to substantially equal compaction at both ends thereof.

Preferably, the compression chamber is mounted pivotably on the frame so that it can be pivoted sequentially through the loading, compacting and ejection positions.

Preferably, the second ram is mounted to the compression chamber for movement with the compression chamber.

The upper ram is preferably mounted on the frame, so that when it is in its retracted position it is clear of the upper end of the compression chamber.

Preferably, a hopper is mounted on the frame and has a feed opening which is aligned with the common inlet and outlet of the compression chamber when the compression chamber is in the first, loading position thereof.

The apparatus preferably includes an actuator operable between the frame and the compression chamber to move the compression chamber between the loading, compacting and ejection positions.

Preferably, the actuator comprises a pair of hydraulic actuators mounted back to back.

The operation of the apparatus is preferably controlled by an automatic or semi-automatic electro/hydraulic control system.

The apparatus preferably includes a hydraulic operating system having a reservoir for hydraulic fluid, a pump for pressurising the hydraulic fluid, and a plurality of valves arranged to control the operation of respective hydraulic actuators to operate the upper and lower rams and to move the compression chamber between the respective positions thereof in an automatic or semi-automatic sequence.

Preferably, at least some of the valves are electrically controllable valves, the apparatus including an electrical control circuit and a plurality of pressure sensors arranged to detect changes in the pressure in the hydraulic operating system due to respective actuators completing their operating strokes, the electrical control circuit actuating respective valves in a predetermined sequence in response to signals from the pressure sensors.

### BRIEF DESCRIPTION OF THE DRAWINGS

FIGS. 1 to 3 are front views of an automatic block making machine according to the invention in loading, compacting and ejection positions, respectively;

FIG. 4 is a side view of the apparatus of FIGS. 1 to 3;

FIG. 5 is a schematic diagram of a hydraulic control circuit of the apparatus; and

FIG. 6 is a schematic diagram of an associated electrical control circuit of the apparatus.

### DESCRIPTION OF AN EMBODIMENT

Although various manually and hydraulically operated block forming machines are available, for example the machine described in South African patent no. 2002/5183, such machines generally still require a number of personnel to operate them, which tends to increase the cost of operating the machines and may lower their productivity. The present invention therefore aims to provide a greater degree of automation in a machine of this general kind.

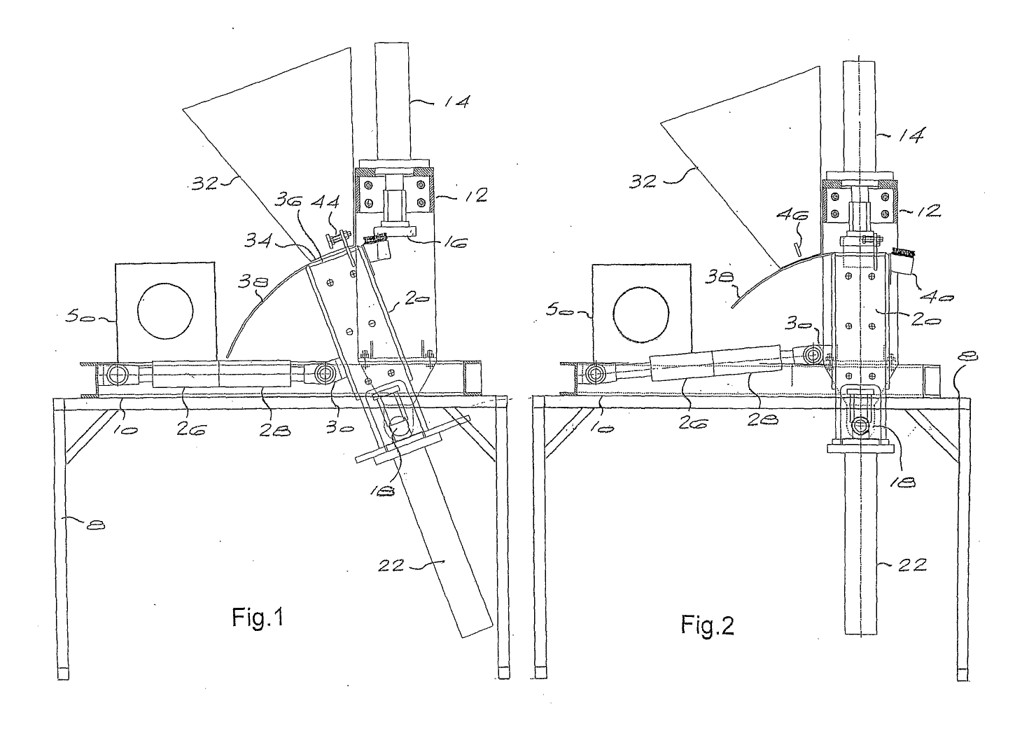

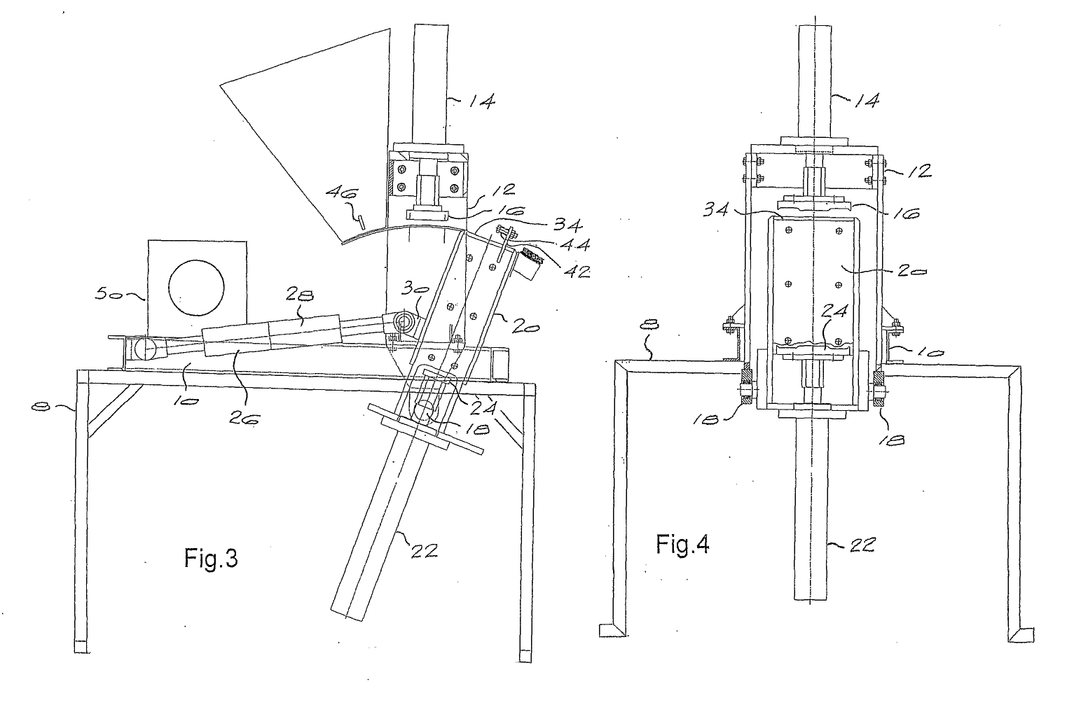

Referring now to FIGS. 1 through 4, the essential components of an automatic block making machine according to the invention are shown. The machine will typically be mounted in use on a mobile frame 8, as shown, or a trailer, together with an electric or internal combustion motor and associated hydraulic pump, and the necessary control circuits (see below). Other mounting and drive arrangements are of course possible.

The machine comprises a horizontal mounting frame 10 formed from steel sections wielded together to define a rectangular structure which in turn is carried by the frame 8. Supported by the mounting frame 10 is an upright reaction frame 12 formed from heavy steel plate. At the top of the reaction frame is mounted a first hydraulic actuator 14 which operates an upper ram 16. Mounted on a pair of heavy duty trunnions 18 is a compression chamber or mould 20 which is formed from heavy steel plate and which is shaped internally to define the profile of a block to be formed. Fixed to the lower end of the compression chamber is a second hydraulic actuator 22 which controls a lower ram 24 which is located towards the lower end of the compression chamber.

The compression chamber can pivot on the trunnions 18 in an arc between three positions, being a loading position as shown in FIG. 1, a compaction position as shown in FIG. 2, and a block ejection position as shown in FIG. 3, driven by first and second positioning actuators 26 and 28 which are connected back to back and which operate between the mounting frame and a bracket 30 on the compression chamber.

The hydraulic actuators 26 and 28 are both double acting actuators which are operated to define the abovementioned three positions of the compression chamber, in which each of the actuators is at one or the other end of its stroke to achieve accuracy and repeatability of movement.

Referring to FIG. 1, with the compression chamber in its loading or filling position, the compression chamber 20 is aligned with a hopper 32 which is fixed to the reaction frame 12. The upper end of the compression chamber is open and defines a common inlet/outlet 34 which, in the position shown in FIG. 1, is aligned with a feed opening 36 defined at the base of the hopper. In use, when the compression chamber is in the loading position, block forming material, typically a soil/cement mixture, is fed by gravity into the compression chamber until the chamber is full.

Referring now to FIG. 2, the first positioning actuator 26 is operated so that it extends fully, while the second position actuator 28 remains fully retracted, thus moving the compression chamber from the loading position shown in FIG. 1 to the compaction position shown in FIG. 2. A curved shield 38 attached to the upper end of the compression chamber closes the feed opening of the hopper as the compression chamber moves towards the compaction position. At the same time, a brush 40 attached to the upper end of the compression chamber at the opposite side from the shield 38 cleans debris from the head of the upper ram 16.

With the compression chamber in the compacting position, the actuator 14 is operated to compress the block making material from the top. A guide is provided on the side of the compression chamber to ensure that the upper ram is aligned with the compression chamber about the centre line of the actuator rod of the first hydraulic actuator 14. The actuator 14 is operated until a predetermined operating pressure is reached, following which the actuator 22 is operated to move the lower ram upwardly in the compression chamber, also to the same predetermined operating pressure. The upper ram is then retracted so that its head is again clear of the upper end of the compression chamber.

In a preferred embodiment of the machine, the same operating pressure is used throughout the system. The pressure can be adjusted through a pressure relief valve to provide a pressure between 0 and 15 MPa. In turn this will result in a maximum force between 0 kN and 75 kN being exerted by the actuators 14 and 22.

Referring now to FIG. 3, the second positioning actuator 28 is now operated and extended fully, while the first positioning actuator 26 remains fully extended, to move the compression chamber to the third, block ejection position shown in FIG. 3. The actuator 22 is now operated to extend the lower ram 24 further upwardly into the compression chamber to eject the block, which can be lifted away from the upper end of the compression chamber and set aside. The lower ram stops 15 mm above (beyond the end of) the chamber, to ensure that the block is completely clear of the chamber when lifting it off, and also to allow cleaning of the ram. The actuators 22 and 28 are now retracted simultaneously. At the ends of the strokes of these two actuators, the pressure in the hydraulic system will rise, triggering the retraction of the actuator 26 and returning the compression chamber to the first, loading position.

Mounted on the upper end of the compression chamber on a bracket 42 is an adjustable striker pin or bolt 44 which is adjusted so that it strikes a striker plate 46 welded to the lower end of the hopper 32. The pin or bolt 44 is adjusted so that it strikes the plate 46 with a suitable degree of force as the compression chamber moves into the loading position under the hopper, to ensure that the soil/cement mixture in the hopper flows into the compression chamber and does not stick in the hopper.

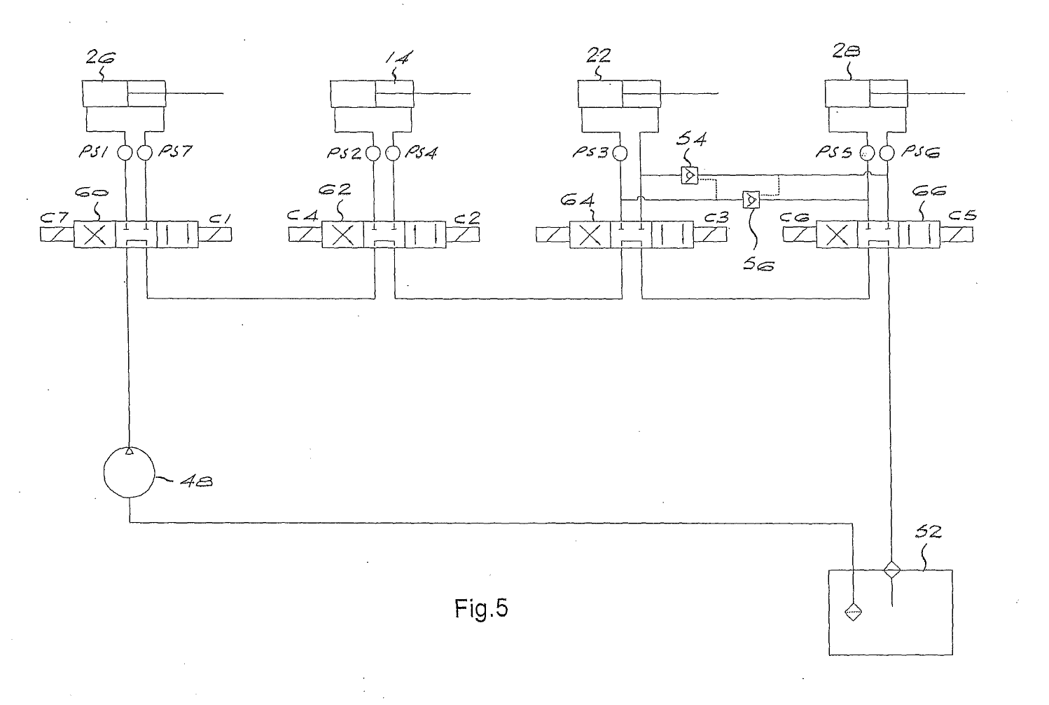

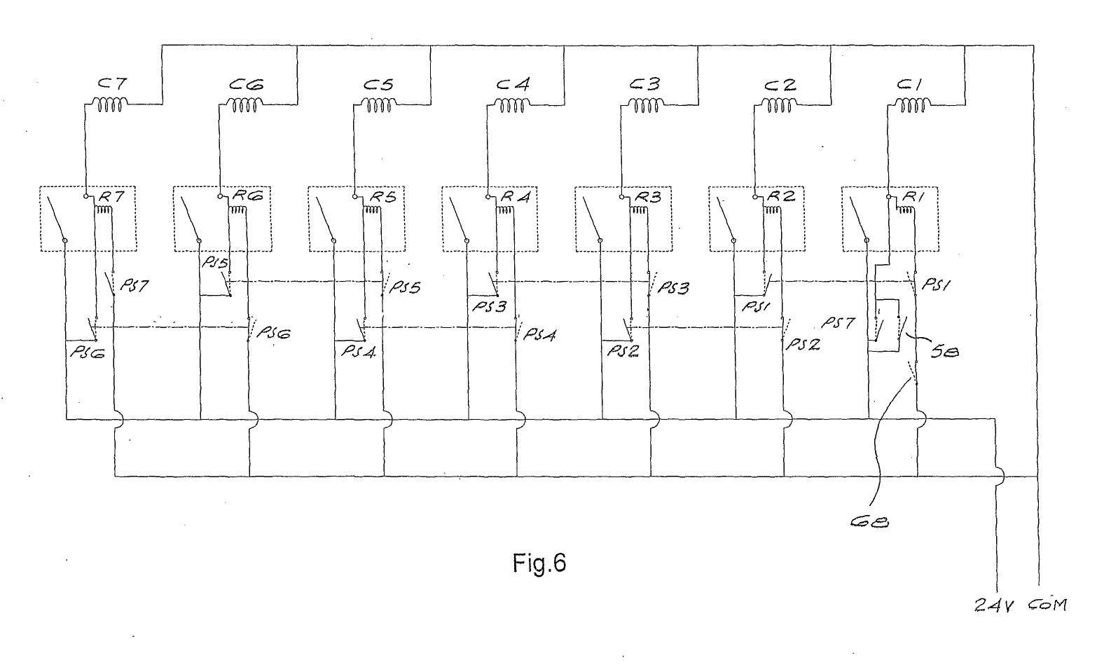

The hydraulic circuit of the apparatus is shown in FIG. 5, and comprises a hydraulic pump 48 arranged to be driven by the motor 50 shown schematically in FIGS. 1 to 4. Hydraulic fluid is drawn from, and returned to, a reservoir 52. Electrically operated valves 60, 62, 64 and 66, with respective operating coils C1 and C7, C2 and C4, C3, and C5 and C6, and a pair of pilot operated check valves 54 and 56, control the operation of the actuators 14, 22, 26 and 28. The associated electrical control circuit is shown in FIG. 6. The electrical circuit primarily comprises several relays R1 to R7 arranged to operate the coils C1 to C7. The relays are controlled by pressure switches PS1 to PS7.

The circuit is designed such that block ejection and compression chamber positioning for block ejection is energised by the same directional control valve, to save time, hence the use of pilot operated check valves.

The sequence of operation is as follows:

Assume that operation starts at the loading position shown in FIG. 1.

When a normally open start button 58 is pressed, the relay R1 closes and energises the coil C1 of the valve 60, to open the valve 60 and to extend the actuator 26. When the actuator 26 reaches the end of its stroke the pressure in its circuit rises and the pressure switch PS1 cuts power to the relay R1 and energises the relay R2. The coil C2 of the valve 62 is energised to open the valve 62 and to extend the actuator 14.

When the actuator 14 sees resistance the pressure in its circuit rises and the pressure switch PS2 cuts power to the relay R2 and energises the relay R3. Consequently the coil C3 of the valve 64 is energised to open the valve 64 and to extend the actuator 22.

When the actuator 22 sees resistance the pressure rises and the pressure switch PS3 cuts power to the relay R3 and energises the relay R4, and subsequently the coil C4 of the valve 62 to open the valve 62 and to retract the actuator 14.

When the actuator 14 reaches the end of its stroke the pressure rises and the pressure switch PS4 cuts power to the relay R4 and energises the relay R5, and consequently the coil C5, to open the valve 66 and to extend the actuators 22 and 28.

When both of the actuators 22 and 28 have reached the ends of their strokes the pressure rises and the pressure switch PS5 cuts power to the relay R5 and energises the relay R6, and consequently the coil C6, to open the valve 66 and to retract the actuators 22 and 28.

When the actuators 22 and 28 have reached the ends of their strokes the pressure rises and the pressure switch PS6 cuts power to the relay R6 and energises the relay R7, and consequently the coil C7, to open the valve 60 and to retract the actuator 26.

When the actuator 26 reaches the end of its stroke the pressure rises and the pressure switch PS7 cuts power to the relay R7 and energises the relay R1, and the sequence starts afresh.

When a stop button 68 is pressed, the sequence will continue until the loading position is reached.

The hydraulic and electrical circuits described above are merely exemplary embodiments of suitable control circuits, and those skilled in the art will appreciate that other embodiments can be utilised to achieve the same functionality.

With prior art machines, the compaction of a block in the compression chamber is generally unequal between the top and bottom of the block, which results in a block being formed with one end weaker than the other. This is due to the fact that, if compaction is applied from one end only, or unequally, friction build-up within the compression chamber reduces the compactive force at the opposing end of the block. The described apparatus offers equal top and bottom compaction of building blocks, which is crucial to ensure even density between the top and bottom of the block. By applying equal compaction force at the top and bottom of the block a more even block density is obtained and higher strength and durability can be achieved with a lower cement content. Poorer soil qualities can also be accommodated more easily than with prior art machines.

1-10. (canceled)

11. Block forming apparatus comprising:
a frame;
a compression chamber having upper and lower opposed ends, the compression chamber being mounted pivotably on the frame for sequential movement between a loading position, a compaction position and a block ejection position thereof;
a pair of double acting actuators operable between the frame and the compression chamber to move the compression chamber between the loading, compaction and block ejection positions thereof, each actuator being operable to be at one or the other end of its stroke, thereby to define the respective loading, compaction and block ejection positions of the compression chamber;
a common inlet and outlet at the upper end of the compression chamber, via which the compression chamber can be charged with block forming material when in the loading position thereof, and via which a formed block can be ejected from the compression chamber when the compression chamber is in the block ejection position thereof;
a lower ram with an associated actuator movable between an extended position in which it extends into the compression chamber towards the upper end thereof, to compress the block forming material from the bottom, and a retracted position towards the lower end thereof;
an upper ram with an associated actuator movable between a retracted position, and a closed position in which it extends into the compression chamber to compress the block forming material from the top; and
a control system arranged to control the operation of the respective actuators, to operate the upper and lower rams and to move the compression chamber between the respective positions thereof in an automatic or semi-automatic sequence, the control system being arranged to operate the actuators associated with the upper and lower rams to the same operating pressure, so that block forming material in the compression chamber is subjected to substantially equal compaction at both ends thereof.

12. Block forming apparatus according to claim 11 wherein the second ram is mounted to the compression chamber for movement with the compression chamber.

13. Block forming apparatus according to claim 11 wherein the upper ram is mounted on the frame, so that when it is in its retracted position it is clear of the upper end of the compression chamber.

14. Block forming apparatus according to claim 11 wherein a hopper is mounted on the frame and has a feed opening which is aligned with the common inlet and outlet of the compression chamber when the compression chamber is in the first loading position thereof.

15. Block forming apparatus according to claim 11 wherein the control system includes a hydraulic operating system having a reservoir for hydraulic fluid, a pump for pressurizing the hydraulic fluid, and a plurality of valves arranged to control the operation of respective hydraulic actuators to operate the upper and lower rams and to move the compression chamber between the respective positions thereof in an automatic or semi-automatic sequence.

16. Block forming apparatus according to claim 15 wherein at least some of the valves are electrically controllable valves, the apparatus including an electric circuit and a plurality of pressure sensors arranged to detect changes in the pressure in the hydraulic operating system due to respective actuators completing their operating strokes, the electrical control circuit actuating respective valves in a predetermined sequence in response to signals from the pressure sensors.
